(19) United States
(12) Patent Application Publication
(10) Pub. No.: US 2010/0068062 A1
(43) Pub. Date: Mar. 18, 2010

(54) Turbine bucket with dovetail seal and related method

(75) Inventors: Paul S. DiMascio, Greer, SC (US); Graham D. Sherlock, Greenville, SC (US); Mark L. Hunt, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenetady, NY (US)

(21) Appl. No.: 12/232,224

(22) Filed: Sep. 12, 2008

(51) Int. Cl. F01D 5/30; F16J 15/10

(52) U.S. Cl. 416/219 R; 277/316; 277/650

(57) ABSTRACT

A method of sealing gaps between a bucket dovetail and a rotor disk dovetail slot in which the bucket dovetail is adapted to be received, the method comprising applying a resin material to selected areas of the bucket dovetail; and inserting the bucket dovetail into the dovetail slot.

### BACKGROUND OF THE INVENTION

This invention relates generally to blades or buckets used in gas turbine engines and more particularly to sealing gaps between dovetails and rotor disk slots.

A gas turbine engine includes a compressor that provides pressurized air to a combustion section where the pressurized air is mixed with fuel and ignited for generating hot combustion gases. These gases flow downstream to one or more turbine stages that extract energy therefrom to drive the compressor and provide useful work such as generating electricity or powering an aircraft in flight. Each turbine stage includes a plurality of circumferentially spaced blades or buckets extending radially outwardly from a rotor disk that rotates about the centerline axis of the engine. Each bucket is mounted on the rotor disk through the engagement of a dovetail portion in a corresponding disk slot. An airfoil portion of the bucket extends radially outward into the hot combustion gas flow. It will be appreciated that one side of the rotor disk is at a relatively higher pressure than the other (downstream) side of the disk.

Because they are exposed to high temperature combustion gases, the buckets are ordinarily cooled to keep their temperatures within certain design limits. One common approach to cooling buckets is to pass a suitable coolant through an internal cooling circuit in the bucket. The coolant normally enters the internal cooling circuit through one or more inlets in the bottom of the bucket dovetail and exits through airfoil tip holes and/or film cooling holes formed in the airfoil surface. Known cooling circuits often include a plurality of radially oriented passages that are series-connected to produce a serpentine path, thereby increasing cooling effectiveness by extending the length of the path.

Since the dovetail inlets are in fluid communication with the disk slot in which the bucket dovetail is located, the coolant is delivered to the inlets via the respective disk slots. However, leakage of coolant flow from the high pressure end to the low pressure end of the disk slots, past the dovetail, will result in reduced coolant flow to the bucket and a corresponding reduction in the service life of the bucket. Thus, it is desirable to seal leakage paths between the dovetail and the slot in which it is mounted. One approach to such sealing is to apply metal strips to specified areas of the dovetail. When the bucket is mounted to the rotor disk by driving the dovetail into the slot, excess strip material is sheared off, leaving a patch of material adhered to the dovetail and filling and thus sealing the corresponding gap between the dovetail and the slot.

In accordance with one prior practice, the metal strip material is applied to the dovetail using thermal spraying techniques. This method requires extensive masking, however, and is very time-consuming and expensive.

In accordance with another prior practice, aluminum patches are wire sprayed onto the dovetails. See, for example, U.S. Pat. No. 6,296,172.

There remains a need for an effective gap-sealing technique that is relatively simple to apply and less time-consuming than prior approaches.

### BRIEF DESCRIPTION OF THE INVENTION

In accordance with one exemplary but non-limiting embodiment of the invention, there is provided a method of sealing gaps between a bucket dovetail and a rotor disk dovetail slot in which the bucket dovetail is adapted to be received, the method comprising applying a resin material to selected areas of the bucket dovetail; and inserting the bucket dovetail into the dovetail slot.

In another aspect, the invention relates to a turbine blade having a mounting portion adapted to be received in a groove having a substantially corresponding shape, wherein selected surface areas of the mounting portion are coated with a water dispersible silicon resin serviceable up to at least 1100° F.

In still another aspect, the invention relates to a sealing arrangement comprising a first component having a mounting portion adapted to be received in a groove formed in a second component having a substantially corresponding shape but with one or more gaps between the mounting portion and surface portions defining the groove, wherein selected surface areas of the mounting portion are coated with a water dispersible silicon resin serviceable up to at least 1100° F. thereby sealing the one or more gaps.

The invention will now be described in greater detail in connection with the drawings identified below.

### BRIEF DESCRIPTION OF THE DRAWINGS

FIG. 1 is a partial, axial end view of a turbine rotor disk including a turbine bucket having a dovetail mounting portion seated in a complimentary groove or slot formed in the rotor disc; and dovetail monitoring portion removed from the disc slot and showing an exemplary implementation of the invention.

FIG. 2 is a perspective view of the turbine bucket of FIG. 1.

### DETAILED DESCRIPTION OF THE INVENTION

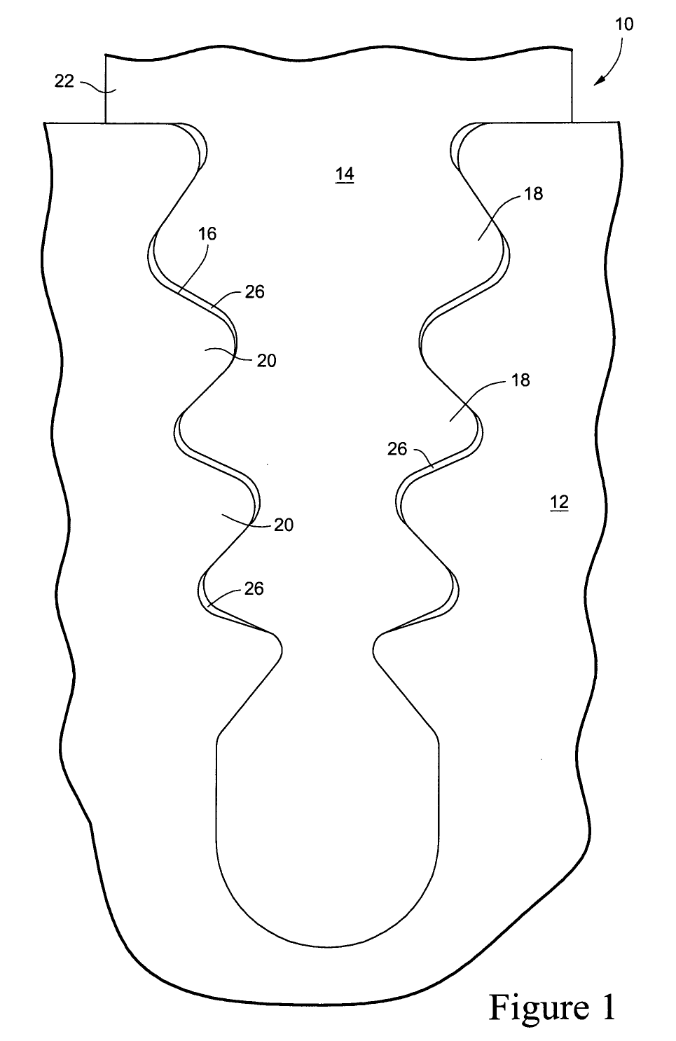

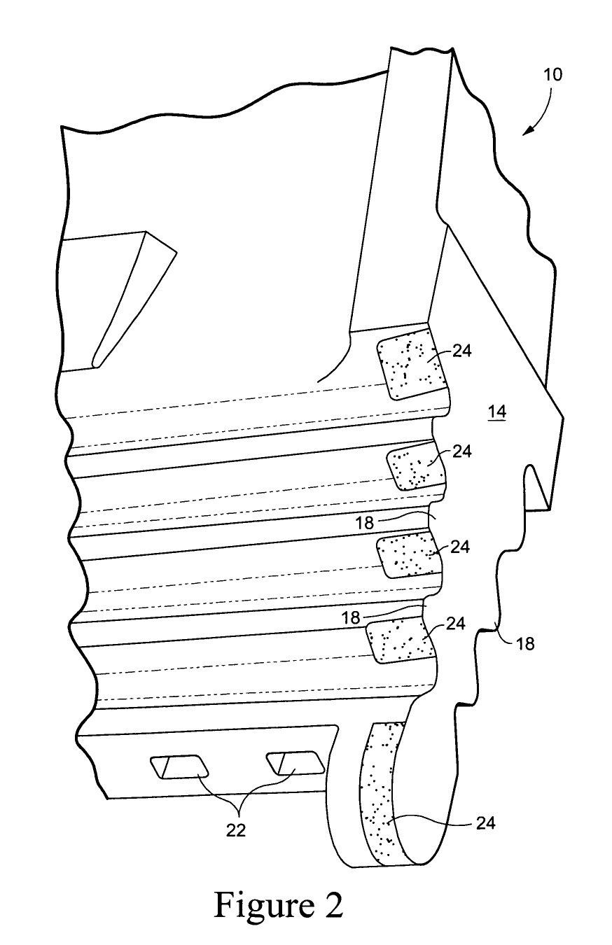

Referring to the drawings wherein identical reference numerals denote the same elements throughout the various views, FIGS. 1 and 2 show an exemplary turbine bucket 10, which is one of a plurality of such buckets mounted to a turbine rotor disk 12 that rotates about the centerline axis of a gas turbine engine. The bucket 10 includes a dovetail portion 14 for mounting the bucket 10 in a corresponding disk slot 16 formed in the rotor disk 12. Specifically, the dovetail portion 14 includes one or more lobes (or mounting surfaces) 18 that engage one or more complementary lobes 20 on the disk slot 16. The dovetail portion 14 and the disk slot 16 are shown to have the so-called fir tree shape although other suitable configurations may be utilized. The bucket 10 is axially loaded into the disk slot 16 and radially retained therein due to the complementary interlocking configurations of the dovetail lobes 18 and the slot lobes 20. The bucket 10 is preferably formed as a one-piece casting of a suitable alloy, such as a nickel-based superalloy, which has acceptable strength at the elevated temperatures of operation in the gas turbine engine.

The bucket 10 includes an airfoil portion (not shown) that extends radially outward from a platform above dovetail portion 14. As is known in the art, the airfoil portion has an internal cooling circuit through which a suitable coolant is passed to keep the bucket temperature within design limits. The coolant enters the internal cooling circuit through one or more inlets 22 (FIG. 2) formed in the bottom of the dovetail portion 14 and located in fluid communication with a passage at the bottom of the disk slot 16. During operation of the gas turbine engine, coolant is delivered to the passage in a conventional manner, from a source that may include, but is not limited to, the engine's compressor. Coolant flows from the passage into the internal cooling circuit (not shown) of the bucket 10 through the inlets 22.

In accordance with an exemplary but nonlimiting implementation, a suitable resin material, e.g., a silicon resin, may be applied to selected areas of the bucket dovetail (and/or to the mating dovetail slot) by a painting process which eliminates the need for time-consuming and costly masking and unmasking processes required in the prior metal spray seal techniques.

One such suitable resin is available from Aremco Products, Inc. under the trade name “Corr-Paint™ CP40XX Series.” The resin is formulated to be serviceable, or in other words, able to withstand prolonged exposure to temperatures of about 1100° F. Other suitable resins with the required properties would also be employed.

As shown in FIG. 1, the seal comprises strips or patches 24 of material (or, simply, seals 24) strategically placed on the undersides of the dovetail lobes 18, at least at the low pressure end thereof, so as to fill corresponding gaps 26 (FIG. 1) between the dovetail lobes 18 and the slot lobes 20. Thus, the seals 24 prevent coolant leakage from the corresponding low pressure end of the disk slot 16. It should be noted however that this is simply one exemplary seal arrangement used to illustrate the inventive concept. Other seal placements are possible depending on bucket design and the cooling configuration.

The foregoing has described a method of quickly and inexpensively applying dovetail seals to turbine buckets or rotor disks by essentially painting the resin material onto the lobes at selected locations. The method requires little surface preparation of the bucket and requires no masking. It will also be appreciated that the resin seal strips or patches 24 may be applied at the manufacturing stage or at service intervals in the field. The silicon resin seals may also have applicability to compressor case abradable seals, to the dampening of a connection slot between the compressor stators and ring, or to any other arrangement of components with mating mounting surfaces.

While specific embodiments of the present invention have been described, it will be apparent to those skilled in the art that various modifications thereto can be made without departing from the spirit and scope of the invention as defined in the appended claims.

What is claimed is:

1. A method of sealing one or more gaps between mounting surfaces on one component and a groove in another component adapted to engage said mounting surfaces comprising:
a) applying a resin on selected portions of said mounting surfaces of said one component; and
b) engaging said mounting surfaces of said one component in said groove of said another component.

2. The method of claim 1 wherein said resin is painted on said selected portions of said mounting surfaces.

3. The method of claim 1 wherein said resin material comprises a water dispersible silicon resin, serviceable to temperature of about 1100° F.

4. The method of claim 1 wherein said one component comprises a turbine bucket dovetail and said another component comprises a rotor disk.

5. The method of claim 4 wherein said bucket dovetail comprises multiple lobes and said resin material in applied to undersides of said lobes.

6. The method of claim 5 wherein said resin material is applied at a low pressure end of said bucket dovetail.

7. The method of claim 4 wherein said resin material is applied when said bucket dovetail is manufactured.

8. A turbine blade having a mounting portion adapted to be received in a groove having a substantially corresponding shape, wherein selected surface areas of said mounting portion are coated with a water dispersible silicon resin serviceable up to at least 1100° F.

9. The turbine blade of claim 8 wherein said mounting portion is substantially dove-tail shaped.

10. The turbine blade of claim 8 wherein said mounting portion comprises plural lobes, said selected surface areas comprising underside surfaces of said lobes.

11. A sealing arrangement comprising a first component having a mounting portion adapted to be received in a groove formed in a second component having a substantially corresponding shape but with one or more gaps between said mounting portion and surface portions defining said groove, wherein selected surface areas of said mounting portion are coated with a water dispersible silicon resin serviceable up to at least 1100° F. thereby sealing said one or more gaps.

12. The sealing arrangement of claim 11 wherein said mounting portion is substantially dove-tail shaped.

13. The sealing arrangement of claim 12 wherein said mounting portion comprises plural lobes, said selected surface areas comprising underside surfaces of said lobes.

14. The sealing arrangement of claim 11 wherein said resin is a silicon resin.
